(19) United States
(12) Patent Application Publication
(10) Pub. No.: US 2020/0151531 A1
(43) Pub. Date: May 14, 2020

(54) RFID TOOL CONTROL SYSTEM

(71) Applicant: Tadbik Advanced Technologies Ltd., Petach Tikva (IL)

(72) Inventors: Guy GOLDBERG, Herzliya (IL); Osnat GUR, Maabarot Kibutz (IL)

(21) Appl. No.: 16/679,400

(22) Filed: Nov. 11, 2019

Related U.S. Application Data
(60) Provisional application No. 62/758,593, filed on Nov. 11, 2018.

(51) Int. Cl. G06K 19/07; G06K 19/077

(52) U.S. Cl. CPC G06K 19/0723; H01Q 1/2208; G06K 19/07758

(57) ABSTRACT

A tuned radio frequency identification (RFID) label retrofittable to an article of manufacture, comprising: an RFID tag having a lower side and an upper side opposite the lower side, the lower side configured to rest against an article of manufacture; a cushioning layer having a lower side and an upper side opposite the lower side, the lower side covering the RFID tag, the cushioning layer attached to the upper side of the RFID tag by a first adhesive layer; and a skirt layer having a lower side attached by a second adhesive layer to the upper side of the cushioning layer.

### CROSS REFERENCE TO RELATED APPLICATIONS

This application claims the benefit of priority of U.S. provisional patent No. 62/758,593 filed on Nov. 11, 2018. The content of this application are incorporated by reference into this application in its entirety.

### FIELD OF THE INVENTION

The present invention generally pertains to a label for flexible, durable attachment of an RFID tag to an article of manufacture after completion of manufacture.

### BACKGROUND OF THE INVENTION

The label of the present invention can be used to convert an AOM into an RFID-equipped smart AOM in a one-step process.

In the prior art, an RFID tag was either integrated into a tool at the time of manufacture or was glued to the surface of the tool. Integration of the RFID tag was typically by insertion of the RFID tag into a predefined recess in the tool and covering the RFID tag with a protective layer, the outer surface of the protective layer being flush with the surface of the tool. Advantages included an RFID tag well protected against damage which did not affect handling of the tool. Disadvantages included a more complex and much more expensive manufacturing process, as well as great difficulty in replacing a non-functioning RFID tag.

Gluing the RFID tag to the surface of the tool avoided the increased manufacturing complexity but had the disadvantages of an increased probability of damage to the RFID tag due to the harsh industrial environments tools are typically exposed to, and interference in the use of the tool due to the protruding RFID tag.

It is therefore a long felt need to provide a label for converting a tool into an RFID-equipped smart tool which does not require a complex manufacturing process, which does not leave the RFID tag unprotected from a harsh environment, and which does not affect the handleability of the tool.

### SUMMARY OF THE INVENTION

It is an object of the present invention to disclose a system and method for flexible, durable attachment of an RFID tag to an article of manufacture after completion of manufacture.

Another object of this patent is to provide a tuned, retrofittable radio frequency identification (RFID) label, characterized by:
a. an RFID tag having a lower side configured to rest against an article of manufacture (AOM) and an upper side opposite to said lower side;
b. a cushioning layer having a lower side covering at least a part of said RFID tag, said cushioning layer attached to at least a portion of said upper side of said covered part of said RFID tag by a first adhesive layer, said cushioning layer having an upper side opposite to said lower side; and
c. a skirt layer having a lower side attached by a second adhesive layer to at least a portion of said upper side of said cushioning layer and to at least a portion of any uncovered part of said upper side of said RFID tag.

Another object of this patent is to provide the label as described in any object above, wherein each said label is supplyable on a removable release layer.

Another object of this patent is to provide the label as described in any object above, wherein a plurality of said labels is supplyable on a single, continuous, removable release layer.

Another object of this patent is to provide the label as described in any object above, wherein said skirt layer is attachable to said AOM by said second adhesive layer.

Another object of this patent is to provide a tuned radio frequency identification (RFID)-labeled article of manufacture (AOM), characterized by:
a. an article of manufacture (AOM);
b. a radio frequency identification (RFID) tag having a lower side configured to rest against said AOM and an upper side opposite to said lower side;
c. a cushioning layer having a lower side covering at least a part of said RFID tag, said cushioning layer attached to at least a portion of said upper side of said covered part of said RFID tag by a first adhesive layer, said cushioning layer having an upper side opposite to said lower side; and
d. a skirt layer having a lower side attached by a second adhesive layer to at least a portion of said upper side of said cushioning layer and to at least a portion of any uncovered part of said upper side of said RFID tag;
said second adhesive layer attaching said skirt layer to said AOM, thereby uniquely associating said RFID tag with said AOM.

Another object of this patent is to provide the label and the RFID-labeled AOM as described in any object above, wherein said AOM is selected from a group consisting of a tool, a part, a rack, a bin, a container, a medical device, a document and any combination thereof.

Another object of this patent is to provide the label and the RFID-labeled AOM as described in any object above, wherein said RFID tag is tunable.

Another object of this patent is to provide the label and the RFID-labeled AOM as described in any object above, wherein said RFID tag comprises a spacer layer.

Another object of this patent is to provide the label and the RFID-labeled AOM as described in any object above, wherein said spacer layer is compressible.

Another object of this patent is to provide the label and the RFID-labeled AOM as described in any object above, wherein said spacer layer comprises a foam.

Another object of this patent is to provide the label and the RFID-labeled AOM as described in any object above, wherein an integrated circuit (IC) in said RFID tag has a location selected from a group consisting of beneath the spacer layer, above the spacer layer and any combination thereof.

Another object of this patent is to provide the label and the RFID-labeled AOM as described in any object above, wherein said cushioning layer is printable.

Another object of this patent is to provide the label and the RFID-labeled AOM as described in any object above, wherein said cushioning layer comprises flexible thermoplastic polymer film.

Another object of this patent is to provide the label and the RFID-labeled AOM as described in any object above, wherein said cushioning layer comprises a material selected from a group consisting of polyurethane (PU), polyvinyl chloride (PVC), polyethylene (PE), polystyrene (PS), acrylic, fluoropolymer, polyester, polyimide and any combination thereof.

Another object of this patent is to provide the label and the RFID-labeled AOM as described in any object above, wherein said cushioning layer comprises a foam.

Another object of this patent is to provide the label and the RFID-labeled AOM as described in any object above, wherein data readable by at least one of a camera, an optical sensor, and an eye is printable on said cushioning layer.

Another object of this patent is to provide the label and the RFID-labeled AOM as described in any object above, wherein data printed on one said cushioning layer differs from data printed on at least one other said cushioning layer.

Another object of this patent is to provide the label and the RFID-labeled AOM as described in any object above, wherein printed data is selected from a group consisting of a name, a logo, a number, a barcode, a picture, and any combination thereof.

Another object of this patent is to provide the label and the RFID-labeled AOM as described in any object above, wherein said AOM is provided with an identifier which is tamper-evident, tamper-proof and any combination thereof.

Another object of this patent is to provide the label and the RFID-labeled AOM as described in any object above, wherein at least a portion of said AOM is curved.

Another object of this patent is to provide the label and the RFID-labeled AOM as described in any object above, wherein a minimum tensile strength for said skirt layer is 20 MPa.

Another object of this patent is to provide the label and the RFID-labeled AOM as described in any object above, wherein a minimum elongation at break for said skirt layer is 400%.

Another object of this patent is to provide the label and the RFID-labeled AOM as described in any object above, wherein a minimum temperature range for a member of a group consisting of said skirt layer, said cushioning layer and said RFID is −20° C. to +60° C.

Another object of this patent is to provide the label and the RFID-labeled AOM as described in any object above, wherein a minimum peel resistance is 10 N, according to Féderation Internationale des fabricants et transformateurs d'Adhésifs et Thermocollants sur papiers et autres supports (FINAT) Test Method 1.

Another object of this patent is to provide the label and the RFID-labeled AOM as described in any object above, wherein said skirt layer comprises at least one tear line.

Another object of this patent is to provide the label and the RFID-labeled AOM as described in any object above, wherein at least one of said at least one tear line comprises at least one notch.

Another object of this patent is to provide the label and the RFID-labeled AOM as described in any object above, wherein a shape of said skirt layer comprises at least one flap.

Another object of this patent is to provide the label and the RFID-labeled AOM as described in any object above, wherein said at least one flap is configured to wrap around said AOM.

Another object of this patent is to provide the label and the RFID-labeled AOM as described in any object above, wherein said skirt layer comprises flexible thermoplastic polymer film.

Another object of this patent is to provide the label and the RFID-labeled AOM as described in any object above, wherein said skirt layer comprises a material selected from a group consisting of PU, PVC, PE, PS, acrylic, fluoropolymer, polyester, polyimide and any combination thereof.

Another object of this patent is to provide the label and the RFID-labeled AOM as described in any object above, wherein said skirt layer comprises PU.

Another object of this patent is to provide the label and the RFID-labeled AOM as described in any object above, additionally comprising a third adhesive layer covering at least a portion of said lower side of said RFID tag, said third adhesive layer configured to attach said RFID tag to said AOM.

Another object of this patent is to provide the label and the RFID-labeled AOM as described in any object above, wherein a member of a group consisting of said first adhesive layer, said second adhesive layer, said third adhesive layer and any combination thereof comprises a pressure-sensitive adhesive, a solvent based adhesive, a hot melt adhesive, an emulsion adhesive, a structural adhesive, a thermosetting adhesive and any combination thereof.

Another object of this patent is to provide the label and the RFID-labeled AOM as described in any object above, wherein a member of a group consisting of said first adhesive layer, said second adhesive layer, said third adhesive layer and any combination thereof comprises permanent acrylic based adhesive.

Another object of this patent is to provide the label and the RFID-labeled AOM as described in any object above, wherein a member of a group consisting of said first adhesive layer, said second adhesive layer, said third adhesive layer and any combination thereof comprises permanent solvent polyacrylate adhesive.

Another object of this patent is to provide the label and the RFID-labeled AOM as described in any object above, wherein a minimum temperature range for at least one of a group consisting of said first adhesive layer, said second adhesive layer and said third adhesive layer is −20° C. to +60° C.

Another object of this patent is to provide a method for a tuned, retrofittable radio frequency identification (RFID) label, characterized by the following steps:
a. providing a tuned, retrofittable RFID label comprising:
   i. an RFID tag having a lower side configured to rest against an article of manufacture (AOM) and an upper side opposite to said lower side;
   ii. a cushioning layer having a lower side covering at least a part of said RFID tag, said cushioning layer attached to at least a portion of said upper side of said covered part of said RFID tag by a first adhesive layer, said cushioning layer having an upper side opposite to said lower side; and
   iii. a skirt layer having a lower side attached by a second adhesive layer to at least a portion of said upper side of said cushioning layer and to at least a portion of any uncovered part of said upper side of said RFID tag;
b. attaching said cushioning layer to said RFID tag by means of said first adhesive layer; and
c. attaching said skirt layer to said cushioning layer and said RFID tag by means of said second adhesive layer.

Another object of this patent is to provide the method as described in any object above, additionally comprising a step of supplying each said label on a removable release layer.

Another object of this patent is to provide the method as described in any object above, additionally comprising a step of supplying a plurality of said labels on a single, continuous, removable release layer.

Another object of this patent is to provide the method as described in any object above, additionally comprising a step of attaching said skirt layer to said AOM by means of said second adhesive layer.

Another object of this patent is to provide a method for a tuned radio frequency identification (RFID)-labeled article of manufacture (AOM), characterized by the following steps:
a. providing a tuned radio frequency identification (RFID)-labeled article of manufacture (AOM) comprising:
   i. an article of manufacture (AOM);
   ii. a radio frequency identification (RFID) tag having a lower side configured to rest against said AOM and an upper side opposite to said lower side;
   iii. a cushioning layer having a lower side covering at least a part of said RFID tag, said cushioning layer attached to at least a portion of said upper side of said covered part of said RFID tag by a first adhesive layer, said cushioning layer having an upper side opposite to said lower side; and
   iv. a skirt layer having a lower side attached by a second adhesive layer to at least a portion of said upper side of said cushioning layer and to at least a portion of any uncovered part of said upper side of said RFID tag;
b. attaching said cushioning layer to said RFID tag by means of said first adhesive layer;
c. attaching said skirt layer to said cushioning layer and said RFID tag by means of said second adhesive layer; and
d. attaching said skirt layer to said AOM by means of said second adhesive layer;
thereby uniquely associating said RFID tag with said AOM.

Another object of this patent is to provide the method as described in any object above, additionally comprising a step of selecting said AOM from a group consisting of a tool, a part, a rack, a bin, a container, a medical device, a document and any combination thereof.

Another object of this patent is to provide the method as described in any object above, additionally comprising a step of providing said RFID tag as a tunable RFID.

Another object of this patent is to provide method as described in any object above, additionally comprising a step of providing said RFID tag comprising a spacer layer.

Another object of this patent is to provide the method as described in any object above, additionally comprising a step of providing said spacer layer comprising compressible material.

Another object of this patent is to provide the method as described in any object above, additionally comprising a step of providing said spacer layer comprising a foam.

Another object of this patent is to provide the method as described in any object above, additionally comprising a step of providing an integrated circuit (IC) in said RFID tag at a location selected from a group consisting of below the spacer layer, above the spacer layer and any combination thereof.

Another object of this patent is to provide the method as described in any object above, additionally comprising a step of providing said cushioning layer as a printable layer.

Another object of this patent is to provide the method as described in any object above, additionally comprising a step of providing said cushioning layer comprising flexible thermoplastic polymer film.

Another object of this patent is to provide the method as described in any object above, additionally comprising a step of providing said cushioning layer comprising a material selected from a group consisting of PU, PVC, PE, PS, acrylic, fluoropolymer, polyester, polyimide and any combination thereof.

Another object of this patent is to provide the method as described in any object above, additionally comprising a step of providing said cushioning layer comprising a foam.

Another object of this patent is to provide the method as described in any object above, additionally comprising a step of printing data readable by at least one of a camera, an optical sensor, and an eye on said cushioning layer.

Another object of this patent is to provide the method as described in any object above, additionally comprising a step of providing data printed on one said cushioning layer different from data printed on at least one other said cushioning layer.

Another object of this patent is to provide the method as described in any object above, additionally comprising a step of selecting printed data from a group consisting of a name, a logo, a number, a barcode, a picture, and any combination thereof.

Another object of this patent is to provide the method as described in any object above, additionally comprising a step of providing said AOM with an identifier which is tamper-evident, tamper-proof and any combination thereof.

Another object of this patent is to provide the method as described in any object above, additionally comprising a step of providing said AOM comprising at least one curved portion.

Another object of this patent is to provide the method as described in any object above, additionally comprising a step of selecting a minimum tensile strength for said skirt layer to be 20 MPa.

Another object of this patent is to provide the method as described in any object above, additionally comprising a step of selecting a minimum elongation at break for said skirt layer to be 400%.

Another object of this patent is to provide the method as described in any object above, additionally comprising a step of selecting a minimum temperature range for a member of a group consisting of said skirt layer, said cushioning layer and said RFID to be −20° C. to +60° C.

Another object of this patent is to provide the method as described in any object above, additionally comprising a step of selecting a minimum peel resistance to be 10 N, according to Féderation Internationale des fabricants et transformateurs d'Adhésifs et Thermocollants sur papiers et autres supports (FINAT) Test Method 1.

Another object of this patent is to provide the method as described in any object above, additionally comprising a step of providing said skirt layer comprising at least one tear line.

Another object of this patent is to provide the method as described in any object above, additionally comprising a step of providing at least one of said at least one tear line comprising at least one notch.

Another object of this patent is to provide the method as described in any object above, additionally comprising a step of selecting a shape for said skirt layer comprising at least one flap.

Another object of this patent is to provide the method as described in any object above, additionally comprising a step of wrapping said at least one flap around said AOM.

Another object of this patent is to provide the method as described in any object above, additionally comprising a step of providing said skirt layer comprising flexible thermoplastic polymer film.

Another object of this patent is to provide the method as described in any object above, additionally comprising a step of providing said skirt layer comprising a material selected from a group consisting of PU, PVC, PE, PS, acrylic, fluoropolymer, polyester, polyimide and any combination thereof.

Another object of this patent is to provide the method as described in any object above, additionally comprising a step of selecting said skirt layer comprising PU.

Another object of this patent is to provide the method as described in any object above, additionally comprising a step of providing a third adhesive layer covering at least a portion of said lower side of said RFID tag, said third adhesive layer configured to attach said RFID tag to said AOM.

Another object of this patent is to provide the method as described in any object above, additionally comprising a step of selecting a member of a group consisting of said first adhesive layer, said second adhesive layer, said third adhesive layer and any combination thereof comprising a pressure-sensitive adhesive, a solvent based adhesive, a hot melt adhesive, an emulsion adhesive, a structural adhesive, a thermosetting adhesive and any combination thereof.

Another object of this patent is to provide the method as described in any object above, additionally comprising a step of selecting a member of a group consisting of said first adhesive layer, said second adhesive layer, said third adhesive layer and any combination thereof comprising permanent acrylic based adhesive.

Another object of this patent is to provide the method as described in any object above, additionally comprising a step of selecting a member of a group consisting of said first adhesive layer, said second adhesive layer, said third adhesive layer and any combination thereof comprising permanent solvent polyacrylate adhesive.

Another object of this patent is to provide the method as described in any object above, additionally comprising a step of selecting a minimum temperature range for at least one of a group consisting of said first adhesive layer, said second adhesive layer and said third adhesive layer to be −20° C. to +60° C.

### BRIEF DESCRIPTION OF THE FIGURES

In order to better understand the invention and its implementation in practice, a plurality of embodiments will now be described, by way of non-limiting example only, with reference to the accompanying drawings, wherein

FIG. 1A-1C schematically illustrates embodiments of RFID tags configured to be used on a conductive AOM;

FIGS. 2-3 schematically illustrate embodiments of the label of the present invention;

FIG. 4 schematically illustrates a tear line in a part of an embodiment of a label; and

FIG. 5 schematically illustrates a cross-section through an embodiment of the label.

### DETAILED DESCRIPTION OF THE PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for generating a label configured for flexible, durable attachment of an RFID tag to an AOM after completion of manufacture.

The term ‘skirt layer’ hereinafter refers to an outermost layer of the label, configured to attach the label to an article of manufacture (AOM) so that the AOM becomes a smart AOM.

The term ‘smart system’ hereinafter refers to a system for automatic identification of each AOM in the system. Typically, the system comprises at least one reader at at least one location, the reader configured to identify any AOM in proximity to the reader.

The term ‘smart AOM’ hereinafter refers to an AOM comprising a tracking tag which enables the AOM to be identified by the smart system.

The figures herein are not to scale.

The RFID label (‘label’) of the present invention can be used to convert an article of manufacture (AOM) into a smart AOM. Preferably, the label is adhered to the AOM in a one-step process; after removal of a release/backing layer, the label is adhered to the AOM via an adhesive layer integrated with the label. The label, once applied to an AOM, provides a tamper-evident RFID-readable identifier for the AOM. Preferably, the label also provides information readable by at least one of an eye, an optical sensor and a camera. Preferably, the applied label is tamper-proof as well as tamper-evident.

The AOM can be, but is not limited to, a tool, a part, a rack, a bin, a container, a medical device, or a document

In the prior art, an RFID tag was either integrated into a tool at the time of manufacture or was fastened to the surface of the tool. Integration of the RFID tag was typically by insertion of the RFID tag into a predefined recess in the tool and covering the RFID tag with a protective layer, the outer surface of the protective layer being flush with the surface of the tool. Advantages included an RFID tag well protected against damage which did not affect handling of the tool. Disadvantages included a more complex and much more expensive manufacturing process, as well as great difficulty in replacing a non-functioning RFID tag.

In the prior art, fastening of an RFID tag to a completed AOM was typically by adhesive, epoxy, rivets, screws, or cable ties, depending on the nature of the AOM. Fastening the RFID tag to the AOM avoided the increased manufacturing complexity but had the disadvantages of an increased probability of damage to or loss of the RFID tag and interference in the use of the tool due to the protruding RFID tag.

The label of the present invention comprises an RFID tag, preferably a flexible RFID tag, covered by a thin, flexible layer, the printable cushioning layer. The cushioning layer is covered by a skirt layer; the RFID tag is attachable to the AOM to be identified by the skirt layer. Typically, an adhesive layer connects the RFID tag and the cushioning layer and a second adhesive layer connects the cushioning layer and the skirt layer, although any method of mechanically connecting the layers can be used. Non-limiting examples of methods of connecting layers include: an adhesive layer, solvent bonding, heat bonding and any combination thereof.

In preferred embodiments, the adhesive layer(s) adhering the skirt layer to the AOM comprise pressure sensitive adhesive, such as an acrylic based adhesive, although any conventional strong adhesive can be used.

At least one adhesive layer can comprise a pressure sensitive adhesive, a solvent based adhesive, a hot melt adhesive, an emulsion adhesive, a structural adhesive, a thermosetting adhesive and any combination thereof.

In some embodiments, at least one other adhesive layer can comprise a pressure sensitive adhesive. In some embodiments, at least one other adhesive layer comprises a solvent based acrylic adhesive.

In some embodiments, at least one of the adhesive layers comprises permanent solvent polyacrylate adhesive.

The cushioning layer provides protection and/or cushioning for the RFID tag and can be printed with variable information readable by at least one of an eye, an optical sensor, and a camera. The variable information can include, but is not limited to, a name, a logo, a number, a barcode, a picture, and any combination thereof. Non-limiting examples of names and numbers include a company ID, a location, a branch ID, a user ID, a part ID and any combination thereof.

The cushioning layer comprises flexible thermoplastic polymer film, the material selected from a group consisting of polyurethane (PU), polyvinyl chloride (PVC), polyethylene (PE), polystyrene (PS), acrylic, fluoropolymer, polyester, polyimide and any combination thereof. Preferably, the cushioning layer comprises PU, PVC and any combination thereof. In some embodiments, the cushioning layer further comprises a foamed material for better cushioning of the RFID tag, for protection of the RFID tag, for greater user comfort, or both.

The skirt layer provides protection both for the RFID tag and for any printing on the cushioning layer, and is the means of attaching the label to an AOM so as to uniquely associate the RFID tag with the AOM. The skirt layer is preferably flexible and durable, capable of withstanding damage from stretching or bending (such as during attachment) and piercing forces.

The skirt layer comprises flexible thermoplastic film, the material selected from a group consisting of PU, PVC, PE, PS, acrylic, fluoropolymer, polyester, polyimide and any combination thereof. Preferably, the skirt layer comprises PU; PU having properties needed for a tamper-evident attachment of the RFID tag to the AOM, namely, it is flexible, durable, resistant to chemical and UV attack, can withstand piercing forces, and is smooth to the touch, thereby making the labeled tool comfortable to use.

In some embodiments, the skirt layer comprises a PU film 130 μm thick; the thickness can range from 90 μm to 170 μm. In preferred embodiments, the skirt layer is transparent and self-healing; scratches can be removed by application of heat (e.g., from a heat gun).

In preferred embodiments, the skirt layer has a tensile strength of ≥34 MPa; a minimum tensile strength for the skirt layer is 20 MPa.

In preferred embodiments, the skirt layer has an elongation at break of ≥550%; a minimum elongation at break is 400%.

Typically, the skirt layer has at least short-term resistance to water, sea water, most oils and greases, fuels, aliphatic solvents, weak acids, salts and alkalis.

In preferred embodiments, the skirt layer and adhesive layers are unaffected by temperatures between −40° C. and +100° C. A minimum temperature range for the RFID, skirt layer, cushioning layer and adhesive layers is −20° C. to +60° C.

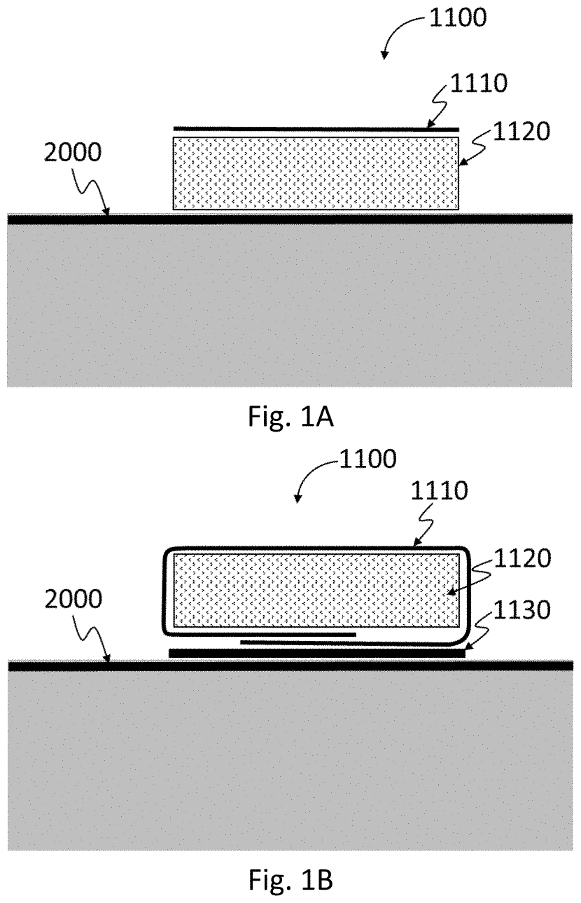

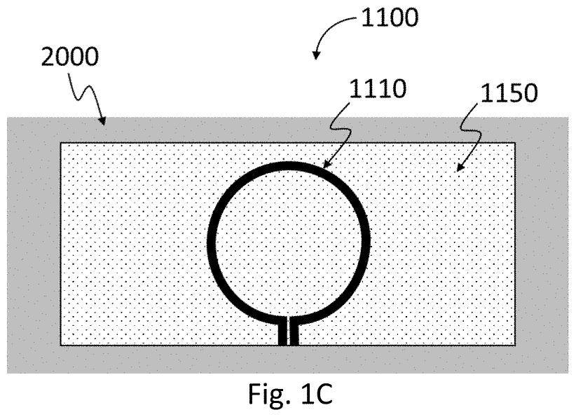

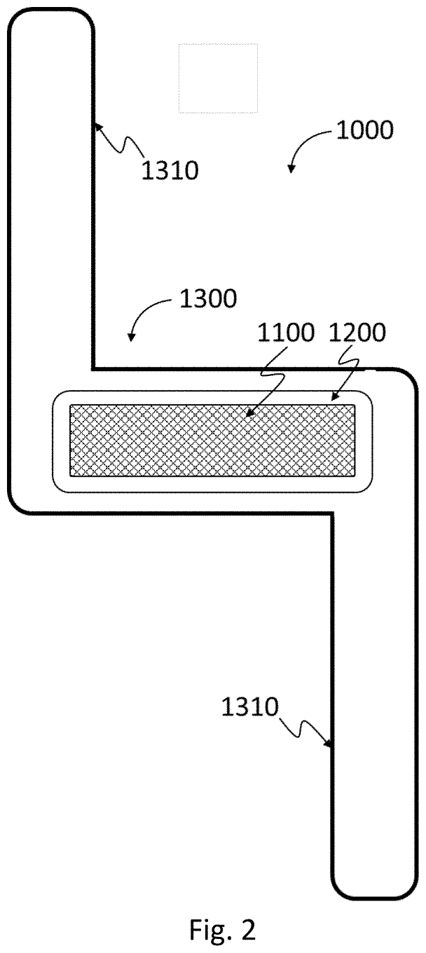

In preferred embodiments, the skirt layer material is selected and the skirt is shaped to minimize peeling. Peeling can be caused by debonding of the adhesive with age, by shrinkage of the skirt layer material with age, by rubbing during use, and any combination thereof. In some embodiments, rubbing is minimized by minimizing contact of a user's hand with the label, as shown by the exemplary embodiment in FIG. 1, disclosed hereinbelow. In some embodiments, peeling is minimized by having a skirt that can conform to the contours of an AOM with only small amounts of stretching and bending, as shown by the exemplary embodiment in FIG. 2, disclosed hereinbelow. Other examples of skirts which can minimize peeling will be obvious to those skilled in the art.

In preferred embodiments, the peel resistance is 18 N, according to Féderation Internationale des fabricants et transformateurs d'Adhésifs et Thermocollants sur papiers et autres supports (FINAT) Test Method 1, 24 h after application of a 25 mm wide strip of adhesivized thermoplastic polymer film to a stainless steel test plate. A minimum peel resistance, according to the above test, is 10 N.

The RFID tag is of a conventional type, preferably configured for use on an AOM comprising conductive material, such as a metal, carbon fiber, a conductive liquid and any combination thereof. Preferably, tuning is provided by the conductive AOM. The RFID tag itself can be either tunable or have a fixed frequency.

In some embodiments, an RFID tag for use on a conductive AOM can comprise at least one spacer layer which can comprise, but is not limited to, a ferrite shield, a shield containing iron particulates in a polymer binder, a non-conductive, nonmagnetic dielectric physical spacer, Styrofoam, carbonyl iron powder, PCB, flexible printed circuit (FPC), ceramic, a foam, a flexible polymer, a composite layer comprising multilayer particles with at least one layer pair, where each layer pair comprises a thin film crystalline ferromagnetic metal layer and a thin film dielectric layer, and any combination thereof.

Preferably, the spacer layer(s) are flexible.

Preferably, at least one spacer layer is compressible.

The antenna in an RFID tag for use on a conductive AOM is preferably of a design which either minimizes interference between the metal and radiation from the RFID reader which is backscattered from the RFID tag, or which utilizes the metal to reinforce the backscattered field. Examples of antenna design include a coupled antenna design or an integrated transponder RFID tag design, and a loop antenna tuned to function at the desired frequency when metal is present.

An integrated circuit (IC) can be provided in the RFID tag. In an RFID tag with at least one spacer layer, the IC is preferably beneath at least one of the spacer layers, with the spacer layer(s) providing protection and cushioning for the IC. In less-preferred embodiments, the IC can be above the spacer layer. In some embodiments, the IC is partly beneath the spacer layer and partly above it.

Preferably, the RFID tag is flexible, allowing the label to follow the contours of an AOM which is curved in at least one direction within at least a portion of the area to be covered by the label, i.e., the AOM is not flat and/or not straight within at least a portion of this area.

Preferably, the spacer layer(s) are compressible, since compression during use can reduce the obtrusiveness of the label during use.

FIG. 1A-C shows embodiments of RFID tags (1100) configured for use on a conductive AOM (2000). The parts are shown separated for clarity.

In FIG. 1A, the conductive AOM (2000) provides the ground for the antenna (1110); antenna (1110) and ground (conductive AOM 2000) are separated by a spacer layer (1120).

In FIG. 1B, the antenna (1110) is wrapped around a spacer layer (1120), forming its own ground. The antenna (1110) is electrically isolated from the conductive AOM (2000) by a dielectric layer (1130).

FIG. 1C schematically illustrates an embodiment of an RFID tag (1100) without a spacer. In this embodiment, the RFID tag (1100) comprises an antenna (1110) and an IC (1150), which can be electrically isolated from a conductive AOM (2000) by a dielectric layer (not shown), or the RFID tag (1100) can be resting on the conductive AOM (2000). The antenna (1110) and IC (1150) can be on opposite sides of a support (not shown), the antenna (1110) and IC (1150) can be on different portion of the same support, with the antenna (1110) and IC (1150) in electrical connection with each other, or the antenna (1110) and IC (1150) can be on separate supports, with the antenna (1110) and IC (1150) in electrical connection with each other. The antenna (1110) is tuned so operate at a desired frequency in the presence of the conductive AOM (2000).

FIG. 2 shows an embodiment of the label (1000). The RFID tag (1100) is covered by a cushioning layer (1200), both being covered by the skirt (1300). In this embodiment, the skirt (1300) comprises two flaps (1310) configured to wrap around an AOM. In this embodiment, the width of the flaps, the wrapping portion, is small to minimize the obtrusiveness of the label to the user, by reducing the portion of the label in contact with a user.

A label (1000) can comprise between one and 10 flaps. The flap(s) can be straight (as shown), curved inward, curved outward, bent inward, bent outward, and any combination thereof.

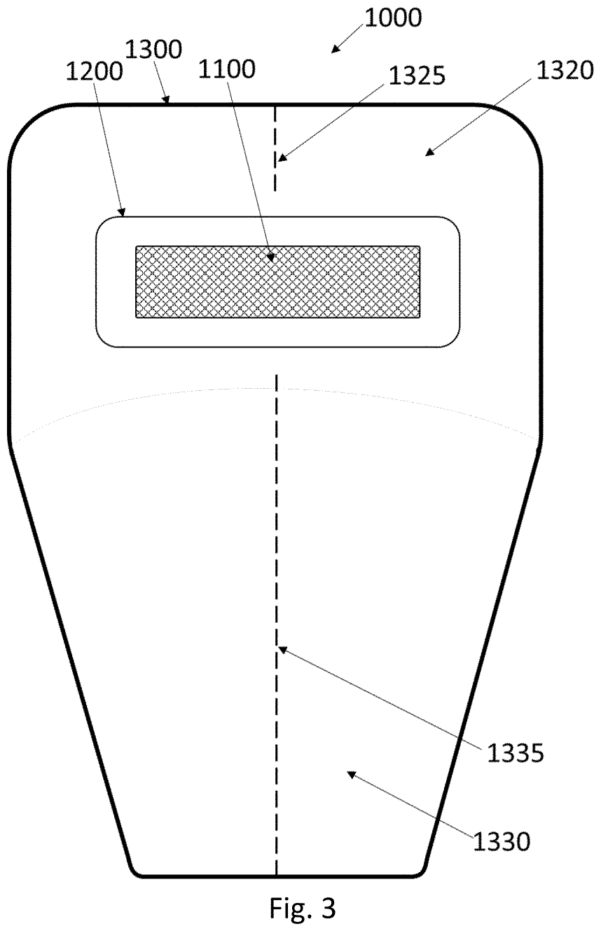

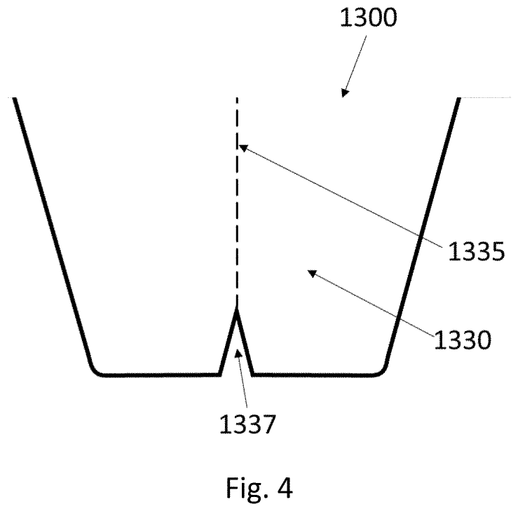

FIG. 3 shows another embodiment of the label (1000). The RFID tag (1100) is covered by a cushioning layer (1200), both being covered by the skirt (1300). In this embodiment, the upper portion (1320) and the lower portion (1330) of the skirt (1300) are configured to wrap around an AOM. As shown, the wrap portions (1320, 1330) are separable along tear lines (1325, 1335) to simplify wrapping curved AOMs, where a tear line (1325, 1335) comprises a narrow region of weakened material. Tear lines can comprise at least one region of thinner material, at least one region comprising a gap in the material, and any combination thereof. In the embodiments of FIGS. 3 and 4, straight tear lines (1325, 1335) are illustrated. Tear lines can be straight, curved and any combination thereof.

In other embodiments, more or fewer tear lines can be used; some embodiments have no tear lines. The maximum number of tear lines in a skirt is 10. Tear lines can be above the RFID tag, below the RFID tag, on a side of the RFID tag and any combination thereof.

FIG. 4 shows a variant of a tear line (1335), exemplified in the lower part of the lower portion (1330) of the skirt (1300) of the embodiment shown in FIG. 3. In this variant of a tear line (1335), the tear line (1335) terminates in a notch (1337) at the edge of the skirt (1300), with the notch making it easier to start tearing along a tear line.

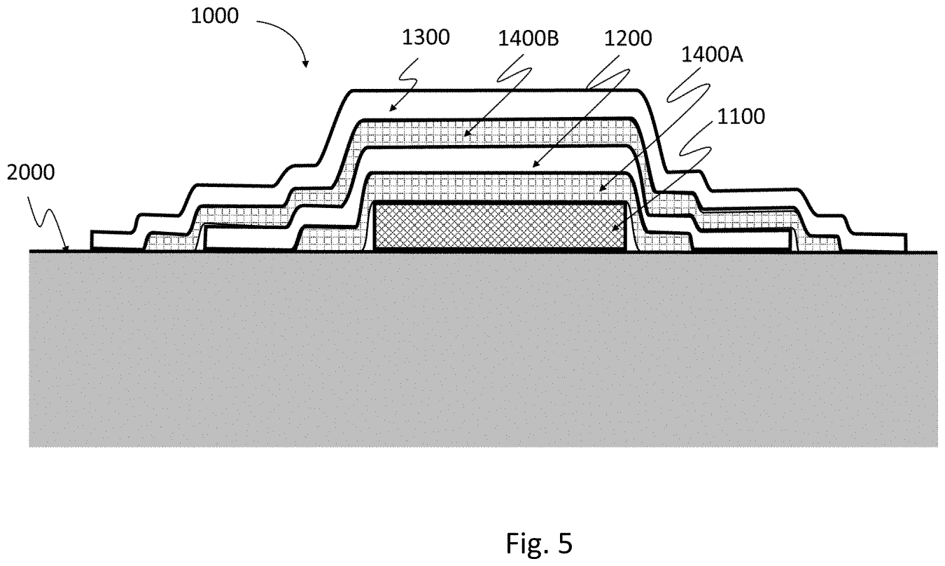

FIG. 5 shows a cross-section through an exemplary embodiment of the label (1000). The label is attached to an AOM (2000) by at least one adhesive layer (1400A, B). Before use, the label (1000) is typically releasably attached to a release liner; removal of the release liner (not shown) exposes the adhesive (1400A, B), allowing attachment of the label (1000) to an AOM (2000). The RFID tag (1100) can rest on the AOM (2000) or can be attached to the AOM (2000) by a third adhesive layer (not shown).

The second adhesive layer, the third adhesive layer and any combination thereof can be applied, either to the tool or to the label, at the point of use. Application at point of use can comprise brushing, spraying, rolling and any combination thereof.

Above the RFID tag (1100) is a first adhesive layer (1400A), which attaches the RFID tag (1100) to the cushioning layer (1200). The first adhesive layer (1400A) and the cushioning layer (1200) can extend beyond the edges of the RFID tag (1100) (as shown), can extend to the edges of the RFID (1100) (not shown) or can be entirely within the area of the RFID tag (1100) (not shown).

The skirt (1300) covers the RFID tag (1100) and the cushioning layer (1200), being attached to the AOM (2000) (which can be a release line, as disclosed hereinabove) and the cushioning layer (1200) (and, if necessary, the RFID tag (1100)) by a second adhesive layer (1400B). The skirt (1300) extends beyond the RFID tag (1100) on at least two opposing sides of the RFID tag (1100), and preferably extends beyond the RFID tag (1100) on all sides thereof.

In preferred embodiments, the label is a one-piece device so that it is applied as a unit after removal of protective or release layer(s). In less-preferred embodiments, the label is a two-piece device, with a first part comprising the RFID tag (1100) and/or an attached cushioning layer (1200) and a second part, comprising a skirt (2000) and/or an attached cushioning layer (1200) to attach the first part to the AOM (2000).

In some embodiments, a plurality of the labels are supplyable on a single continuous release/backing layer, with each of the labels individually removable from the backing layer and attachable to an AOM upon removal from the backing layer. The backing layer can be folded or can form a roll.

1.-134. (canceled)

135. A tuned, retrofittable radio frequency identification (RFID) label comprising:
an RFID tag having a lower side configured to rest against an article of manufacture (AOM) and an upper side opposite to said lower side;
a cushioning layer having a lower side covering at least a part of said RFID tag, said cushioning layer attached to at least a portion of said upper side of said covered part of said RFID tag by a first adhesive layer, said cushioning layer having an upper side opposite to said lower side; and
a skirt layer having a lower side attached by a second adhesive layer to at least a portion of said upper side of said cushioning layer and to at least a portion of any uncovered part of said upper side of said RFID tag.

136. The label of claim 135, wherein each said label is supplyable on a removable release layer.

137. The label of claim 135, wherein at least one of the following is true:
a. said skirt layer is attachable to said AOM by said second adhesive layer;
b. said AOM is selected from a group consisting of a tool, a part, a rack, a bin, a container, a medical device, a document and any combination thereof;
c. said RFID tag is tunable; and
d. said RFID tag comprises a spacer layer.

138. The label of claim 137, wherein said spacer layer is compressible.

139. The label of claim 137, wherein said spacer layer comprises a foam.

140. The label of claim 135, wherein at least one of the following is true:
a. said cushioning layer is printable;
b. said cushioning layer comprises flexible thermoplastic polymer film;
c. said cushioning layer comprises a material selected from a group consisting of polyurethane (PU), polyvinyl chloride (PVC), polyethylene (PE), polystyrene (PS), acrylic, fluoropolymer, polyester, polyimide and any combination thereof;
d. said cushioning layer comprises a foam;
e. said cushioning layer carries data printed thereon; said data is readable by at least one of a camera, an optical sensor, and an eye.

141. The label of claim 135, wherein at least one of the following is true:
a. said AOM is provided with an identifier which is tamper-evident,
b. said AOM is provided with an identifier which is tamper-proof, and
c. at least a portion of said AOM is curved.

142. The label of claim 135, wherein at least one of the following is true:
a. a minimum tensile strength for said skirt layer is 20 MPa; and
b. a minimum elongation at break for said skirt layer is 400%.

143. The label of claim 135, wherein a minimum peel resistance is 10 N, according to Féderation Internationale des fabricants et transformateurs d'Adhésifs et Thermocollants sur papiers et autres supports (FINAT) Test Method 1.

144. The label of claim 135, wherein at least one of the following is true:
a. said skirt layer comprises at least one tear line; and
b. a shape of said skirt layer comprises at least one flap.

145. The label of claim 145, wherein at least one of said at least one tear line comprises at least one notch.

146. The label of claim 145, wherein said at least one flap is configured to wrap around said AOM.

147. The label of claim 135, wherein said skirt layer comprises flexible thermoplastic polymer film.

148. The label of claim 135, wherein said skirt layer comprises a material selected from a group consisting of PU, PVC, PE, PS, acrylic, fluoropolymer, polyester, polyimide and any combination thereof.

149. The label of claim 135, wherein said skirt layer comprises PU.

150. The label of claim 135, additionally comprising a third adhesive layer covering at least a portion of said lower side of said RFID tag, said third adhesive layer configured to attach said RFID tag to said AOM.

151. The label of claim 150, wherein a member of a group consisting of said first adhesive layer, said second adhesive layer, said third adhesive layer and any combination thereof comprises a member of a group consisting of a pressure-sensitive adhesive, a solvent based adhesive, a hot melt adhesive, an emulsion adhesive, a structural adhesive, a thermosetting adhesive and any combination thereof.

152. The label of claim 150, wherein a member of a group consisting of said first adhesive layer, said second adhesive layer, said third adhesive layer and any combination thereof comprises permanent acrylic based adhesive.

153. The label of claim 150, wherein a member of a group consisting of said first adhesive layer, said second adhesive layer, said third adhesive layer and any combination thereof comprises permanent solvent polyacrylate adhesive.
